(19) United States
(12) Patent Application Publication
(10) Pub. No.: US 2010/0332541 A1
(43) Pub. Date: Dec. 30, 2010

(54) METHOD FOR IDENTIFYING A MULTIMEDIA DOCUMENT IN A REFERENCE BASE, CORRESPONDING COMPUTER PROGRAM AND IDENTIFICATION DEVICE

(75) Inventors: Nicolas Gengembre, Plechatel (FR); Patrick Lechat, Vern Sur Seiche (FR); Sid Ahmed Berrani, Rennes (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/865,309

(22) PCT Filed: Jan. 28, 2009
(86) PCT No.: PCT/FR09/50129

§ 371 Date: Jul. 29, 2010

(30) Foreign Application Priority Data
Jan. 30, 2008 (FR) 0850580

(51) Int. Cl. G06F 17/30

(52) U.S. Cl. 707/780; 707/E17.014

(57) ABSTRACT

A method is provided for identifying a multimedia document, aimed at verifying whether the multimedia document to be identified is similar or not to at least one multimedia document referenced in a base of reference multimedia documents. The method includes assignment of a number of votes to at least one reference multimedia document and selection of multimedia documents similar to the multimedia document to be identified. The selection step includes: determining a probabilistic distribution of the number of votes assigned to a reference multimedia document, as a function of the total number of documents referenced in the base and of the total number of votes, under a random voting assumption; and obtaining a threshold of selection of the similar multimedia documents from among the reference multimedia documents, on the basis of the probabilistic distribution.

### CROSS-REFERENCE TO RELATED APPLICATIONS

This Application is a Section 371 National Stage Application of International Application No. PCT/FR2009/050129, filed Jan. 28, 2009 and published as WO 2009/095616 on Aug. 6, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the transmission or exchange of multimedia documents, for example an image, a video, an audio content, textual content etc.

More specifically, the disclosure pertains to the identification of such multimedia documents, especially in order to detect copies of a referenced content (for example illicit copies of a protected document).

### BACKGROUND OF THE DISCLOSURE

### 1. Detection of Illicit Copies

The advent of high-bit-rate applications offered by ADSL has led to the emergence of new services for facilitated consumption of multimedia content, such as video-on-demand services.

Classic providers such as France Television, TF1, Gaumont (registered marks) etc. as well as other actors from the telecom world such as Orange, Neuf, Free (registered marks) etc., search engines such as Google Video, Yahoo Video etc (registered marks) or else specialist companies such as vodeo.fr, glowria, blinkx, TVEyes, skouk, (registered marks) etc. thus propose part of their video catalogues on line. The multimedia contents proposed by these services are protected and can be downloaded, subject for example to the payment of a fee.

Besides, the recent development of multimedia document exchange sites such as YouTube, DailyMotion, MySpace (registered marks) etc. are revealing the existence of a second source of multimedia documents. These documents come from the users themselves. Unfortunately, although a part of the documents observed on these exchange sites come from documents truly created by the users, another part is constituted by contents illegally proposed for downloading.

It is therefore desirable to be able to detect illicit copies of a protected multimedia document.

More specifically the detection of video copies can be used to:
identify the contents referenced in catalogues, i.e. referenced in a reference base, in order to detect the illicit copies of the reference contents;
list heavily copied contents (by deduplication) in order to detect audience-generating contents or restrict storage sizes;
locate an integral program from a short extract.

Such detection should be capable of taking into account the usual degradation undergone by a multimedia document in this context: high compression, resampling, cropping as well as overlay of text, logos, camcording etc. Indeed, a copied multimedia document generally undergoes intentional transformations designed to make it hard to detect, as well as unintentional transformations caused by the recording of the content, its transcoding, or editorial constraints when it is republished.

Classically, the detection of copies of multimedia documents (images, sounds, videos etc) consists in searching for the presence or absence of a “suspect” request document in a base of protected documents. Such a technique relies on two essential aspects:
the description of the visual content of the multimedia document, i.e. the descriptors used;
the technique of indexing the descriptors, i.e. the method used to structure the base of the descriptors of the protected documents, enabling the searches to be made efficiently.

### 2. Descriptors of Documents

Traditionally, the descriptor of a document is a digital vector that represents the content of the document or of a part of the document in summarizing it.

In video content analysis, it is common practice to use a description based on the key images. This technique is one of selecting a subset of images, called key images, from a video type document and describing these key images. For example, these key images may come from an algorithm which adaptively selects the images representing video or a regular, time-related sub-sampling process selecting for example one image per second. These key images are represented by one or more descriptors computed from the visual content of the image.

Two approaches can be distinguished for the descriptors:
local approaches: from each key image, a set of points of interest are selected in the image. These points of interest correspond to visibly outstanding points of the image which can be found even after deterioration. A descriptor is then computed in the vicinity of each point of interest;
comprehensive approaches: each image of the video, or each key image of the video is described as a whole by computing only one descriptor.

In particular, the descriptors must be robust with respect to the deterioration of documents.

Thus, a large part of the techniques for detecting copies of multimedia documents uses a local description of a document, considering the local descriptors to be more robust than the comprehensive descriptors. The information describing the multimedia documents is thus distributed over different regions of the document. Consequently, the deterioration of some of these regions (for example during the overlay of a logo in an image or else during the cropping of the image) does not affect the other regions which can be used to identify the document).

### 3. Search by Similarity

As already indicated, the detection of copies of a multimedia document consists in searching for the presence or absence of a request document to be identified in a base of protected documents.

This search relies on two distinct phases:
a phase known as an “offline” phase of building the base of reference multimedia documents;
a phase known as an “online” phase of searching for the presence or absence of the document to be identified in the reference base.

More specifically, the search phase associates a measurement of similarity (often a distance) with a document to be identified. This measurement of similarity quantifies the resemblance between two documents by measuring the proximity between their respective descriptors.

In an application for detecting video copies for example, a search is made not only for identical documents but also for documents having moderate resemblance, for taking into account possible deteriorations in the video.

Conversely, it is not enough for two documents to have a few descriptors in common to be copies of one another (for example, two text documents can have words in common without in any way dealing with the same subject).

It is therefore desirable to efficiently define the degree of similarity (also called selection threshold) that is the starting point from which the documents are deemed to have a significant resemblance.

Indeed, an excessively low threshold would prompt many false alarms in which dissimilar multimedia documents would be considered to be similar whereas an excessively high threshold would lead to non-detection because certain similar documents (similar documents not returned by the system) would not be detected.

FIG. 1 gives a more precise illustration of the different steps implemented for the phase of online search of the presence or absence of a document to be identified in the reference base.

We consider for example a document to be identified Q11, corresponding to an image.

In a first description step 12, a set of m local descriptors is extracted from the document to be identified. It is deemed to be the case that the more complex the image, the greater the increase in the number of local descriptors. Conversely, if the image is simple (an image representing the sky for example) the number of descriptors is small.

During a following search step 13, a request to the base of reference multimedia documents 14 forwards, for each of the m descriptors, a set (zero, one or more) of candidate documents coming from the reference base and having a similar descriptor. In other words, each descriptor j (for j ranging from 1 to m) has Dj candidate documents from the base 14 associated with it.

In particular, it can be noted that certain of the candidate documents sent appear several times, i.e. they are forwarded by several of the m requests, during the step 13 of searching by similarity in the reference base.

During a following step for selecting similar documents 15, a decision is made, depending on the number of their appearances, as to which documents can be considered to be similar to the document 11 to be identified. The step 16 for selecting similar documents can therefore be likened to a vote-counting phase: each descriptor j of the document 11 to be identified is considered to be “voting” for the (zero, one or more) candidate documents, and the candidate documents that have received the greatest number of votes will be the closest to the document to be identified. Thus a set of documents similar to the document to be identified is obtained.

Different techniques are presented in the literature for counting votes in a system of searching for similar documents in a reference base.

Thus, a first technique relies on an absolute thresholding system. In other words, only the candidate documents that have received a number of votes above a predetermined threshold are kept.

It must be noted that a technique of this kind has low performance because it is not suited to the total number of votes sent or to the size of the reference base. It therefore generates an increased number of false alarms and non-detections.

Another technique presented by S.-A. Berrani, L. Amsaleg, and P. Gros. (“Robust Content-Based Image Searches for Copyright Protection”, Proceedings of the ACM International Workshop on Multimedia Databases, pages 70-77, New Orleans, La., USA, November 2003) relies on an analysis of the ordered list of candidate documents by rising order of number of votes. A leap search method (known as the Page-Hinkley method) is used to separate the list of non-significant votes from the list of votes that are significant.

Unfortunately, this technique requires a phase for ordering candidate documents by the number of votes received. This technique also requires that the candidate documents for which the similarity is significant should be sharply distinguished from the background noise (corresponding to non-significant votes). Such a technique therefore entails constraints and is costly in terms of resources and time.

### SUMMARY

The disclosure proposes a novel solution that does not have these prior art drawbacks, in the form of a method for identifying a multimedia document, aimed at checking on whether or not the multimedia document to be identified is similar to at least one reference multimedia document referenced in a base of reference multimedia documents, comprising the following steps:

allotting a number of votes to at least one reference multimedia document, each of said votes being significant of a proximity between a descriptor of said reference multimedia document and a descriptor of said multimedia document to be identified,

selecting, from among said at least one reference multimedia document, multimedia documents similar to said multimedia document to be identified.

According to the disclosure, the selection step comprises the following sub-steps:

determining a probabilistic distribution of the number of votes allotted to a reference multimedia document as a function of the total number of documents referenced in said base and of the total number of votes, given an assumption of random voting,

obtaining a threshold of selection of said similar multimedia documents, from among the reference multimedia documents, on the basis of said probabilistic distribution.

Thus, the disclosure proposes a novel and inventive solution for automatically determining a threshold of selection of reference multimedia documents similar to the multimedia document to be identified.

To this end, one considers a number of votes allotted to at least one reference multimedia document and for example to all the documents referenced in the base. Thus, this number of votes will be equal to zero for a document that has received no votes.

The multimedia documents (reference documents and documents to be identified) may be still images, videos, audio contents, text contents etc. These multimedia contents are each described by at least one descriptor.

More specifically, if the multimedia documents (documents to be identified and reference documents) are described by at least two local descriptors, characterizing an aspect and/or a region of said multimedia documents, then a vote is allotted to a reference multimedia document when one of the descriptors of the multimedia document to be identified is similar to one of the descriptors of the reference multimedia document.

If the multimedia documents (documents to be identified and reference documents) are described by an overall vector descriptor comprising at least two components, then a vote is allotted to a reference multimedia document when one of the components (or sub-set of components) of the descriptor of the multimedia document to be identified is similar to one of the components (or sub-set of components) of the descriptor of the reference multimedia document.

Then, a probabilistic distribution of the number of votes allotted to a reference multimedia document is determined as a function of the total number of documents referenced in the base and the total number of votes. In other words, this probabilistic distribution is valid for all the reference documents. It is used to represent the number of votes allotted to a document i, assuming random voting. This probabilistic distribution is also called a probabilistic representation of the distribution of the number of votes, or a probabilistic modeling.

One then obtains a threshold of selection of similar multimedia documents, among the reference multimedia documents of the base, on the basis of this probabilistic distribution.

In particular, the selection threshold is defined by taking into account the number of possible false alarms, estimated from said probabilistic distribution, so that the number of false alarms for the selection threshold is smaller than a predetermined decision value ε.

This selection threshold therefore takes into account the previously determined probabilistic distribution.

More specifically, a “false alarm” for a reference multimedia document amounts to considering this document to be similar to the document to be identified, whereas it is not similar. The number of false alarms can be expressed by the product of the following: the total number of multimedia documents referenced in the base and the probability that a reference multimedia document will have a number of votes greater than or equal to the selection threshold S. Again, this probability is computed on an assumption of random voting.

For example, the decision value is chosen to be equal to 1 (ε=1).

The choice of this decision value makes it possible especially to remove the need for one parameter.

Indeed, in fixing this value at 1, it is known that, statistically, less than one reference multimedia document among all the reference multimedia documents will receive a number of votes above the threshold S if the votes occur randomly. If a particular reference multimedia document receives a number of votes above this threshold S, then a false alarm is observed whereas the probabilistic distribution according to the random voting predicts fewer such observations.

Thus, it can be assumed that a number of votes of this kind cannot be caused by chance but rather by a certain similarity with the multimedia document to be identified.

According to one particular aspect of the disclosure, where the random votes are uniformly distributed, the probabilistic distribution implements a binomial law with parameters V and 1/n, denoted as

$$B ( {V}_{i} ; V , \frac{1}{n} ) ,$$

where:
n is the total number of multimedia documents referenced in the base;
V is the total number of votes;
Vᵢ is the number of votes for a reference multimedia document i referenced in the base.

A law of this kind corresponds to the following experiment: a Bernoulli trial with a parameter 1/n (a random experiment with two possible outcomes, generally named respectively as “success” and “failure” with a chance of success of 1/n) is repeated V times independently. Then, the number of successes Vᵢ obtained at the end of the V trials is counted.

The set of values taken by Vᵢ then follows the binomial law

$$B ( {V}_{i} ; V , \frac{1}{n} )$$

In particular, the binomial law can be approximated by a Poisson law with a parameter L=V/n, according to the following equation:

$$B ( k ; V , \frac{1}{n} ) \approx \frac{{L}^{k}}{k !} exp ( - L ) .$$

This approximation especially simplifies the numerical implementation of the computations and minimizes the computation time.

In particular, the step for obtaining a selection threshold implements an iterative algorithm on the basis of a selection threshold setting value equal to zero and so long as the number of false alarms for the selection threshold is greater than the decision value ε.

This iterative algorithm can be especially implemented when the binomial law is approximated by a Poisson law.

According to one variant, the selection threshold S is determined prior to selection step for different values of the total number of multimedia documents referenced in said base (n) and of the total number of votes (V), and is stored in a table. Obtaining the selection threshold then puts a reading of the table into operation.

Another aspect of the disclosure pertains to a computer program product downloadable from a communications network and/or recorded on a computer-readable carrier and/or executable by a processor, comprising program code instructions for implementing the identification method described here above.

In another embodiment, the disclosure pertains to an identification device for identifying a multimedia document aimed at checking on whether or not the multimedia document to be identified is similar to at least one reference multimedia document referenced in a base of reference multimedia documents, said multimedia documents to be identified and reference multimedia documents being described by at least one descriptor, comprising:
means for allotting a number of votes to at least one reference multimedia document, each of said votes being significant of a proximity between a descriptor of said reference multimedia document and a descriptor of said multimedia document to be identified,
selecting means for selecting, from among said at least one reference multimedia document, multimedia documents similar to said multimedia document to be identified.

According to this embodiment, the selecting means comprises:
means for determining a probabilistic distribution of the number of votes allotted to a reference multimedia document, as a function of the total number of documents referenced in said base and of the total number of votes, given an assumption of random voting,
means for obtaining a threshold of selection of said similar multimedia documents, from among the reference multimedia documents, on the basis of said probabilistic distribution.

An analyzing device such as this is especially adapted to implementing the identification method described here above. It is for example included in an analysis server enabling the exchange or downloading of multimedia documents and especially the detection of copies of multimedia documents.

### BRIEF DESCRIPTION OF THE DRAWINGS

Other features and advantages of the disclosure shall appear more clearly from the following description of a particular embodiment given by way of a simple and non-exhaustive illustrative example, and from the appended drawings of which:

FIG. 1 presents the different steps implemented for the search for similar documents in the prior art;

FIG. 2 illustrates the main steps of the identification method according to the disclosure;

FIG. 3 represents an example of a distribution of probability of the number of votes, with the assumption of random voting;

FIG. 4 shows the structure of an identification device according to one particular embodiment of the disclosure.

### DETAILED DESCRIPTION OF ILLUSTRATIVE EMBODIMENTS

### 1. General Principle

The general principle of the disclosure relies on the use of a probabilistic approach to analyze a multimedia document, i.e. to check on whether one or more multimedia documents referenced in a base of reference multimedia documents are similar (or not) to the multimedia document to be identified. Such a multimedia document may be an image (possibly extracted from a video), a video, an audio content, textual content etc.

More specifically, the disclosure can be used to decide which reference multimedia documents can be considered to be similar to the document to be identified, while taking into account an automatically determined selection threshold.

The term “automatically determined selection threshold” is understood to mean a threshold that is not pre-established (as in the techniques implementing an absolute thresholding) but is computed automatically by the algorithm of the disclosure.

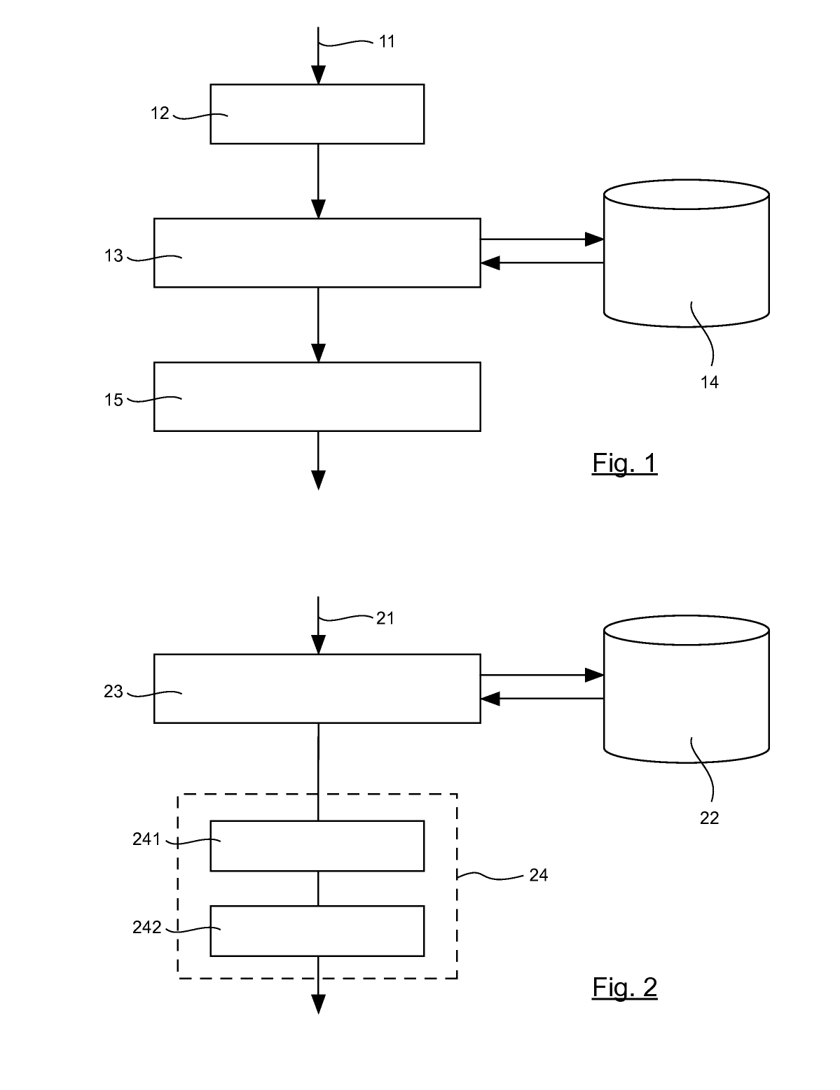

FIG. 2 provides a more precise illustration of the general principle of the identification of a multimedia document according to the disclosure, aimed at checking on whether or not a multimedia document to be identified 21 is similar to at least one multimedia document referenced in a base 22 of reference multimedia documents, each described by at least one descriptor.

To this end, during a first step 23, a number of votes is allotted to at least one of the multimedia documents referenced in the base 22. Each of these votes signifies a proximity between a descriptor of the reference multimedia document and a descriptor of the multimedia document to be identified. For example, a number of votes is allotted to each of the documents referenced in the base 22. The reference documents that do not receive any votes are assigned a number of votes equal to zero.

For example, in the case of a multimedia document described from local descriptors, zero, one or more reference multimedia documents are associated with each local descriptor j, in searching in the base 22 for the reference multimedia documents comprising this descriptor or a descriptor close to it (in terms of distance for example). In other words, each descriptor j of the document to be identified is considered to be “voting” for reference multimedia documents (zero, one or more documents).

In the case of a multimedia document described from a comprehensive descriptor, zero, one or more reference multimedia documents are associated with each component of the comprehensive descriptor. In other words, each component of the comprehensive descriptor of the document to be identified is considered to be “voting” for the reference multimedia documents (zero, one or more documents).

For example, if the base 22 has four reference multimedia documents denoted as D1 to D4 and if the multimedia document to be identified is described by three local descriptors, the first local descriptor can vote for the reference multimedia documents D1 and D3, the second local descriptor can vote for the reference multimedia document D3, and the third local descriptor can vote for none of the reference multimedia documents. Then, the number of votes allotted to the document D1 will be equal to 1, the number of votes allotted to the documents D2 and D4 will be zero, and the number of votes allotted to the document D3 will be equal to 2. The total number of votes will then be equal to 3.

Then the multimedia documents similar to the multimedia document 21 to be identified are selected (24) in the base 22.

To this end, first of all the disclosure determines (241) a probabilistic distribution of the number of votes allotted to a reference multimedia document as a function of the total number of documents present in the base and the total number of votes, given an assumption of random voting. A modeling of this kind is valid for all the reference multimedia documents.

Then (242), a threshold is obtained for selecting similar multimedia documents among the reference multimedia documents of the base, on the basis of the probabilistic distribution, the similar multimedia documents having a number of votes above the selection threshold. To this end, it is possible especially to take into account the number of possible false alarms estimated from the probabilistic distribution.

In other words, only the reference multimedia documents having a number of votes above the selection threshold are considered to be documents similar to the multimedia document to be identified.

In particular, the method of the disclosure can be implemented in various ways, especially in wired or software form.

### 2. Case of Local Descriptors

Here below, one describes an example of implementation of the disclosure in which the probabilistic distribution of the number of channels assigned to the reference multimedia documents is a binomial distribution. It can also be considered that the number of multimedia documents to be identified is described by a plurality of local descriptors.

More specifically, n denotes the number of reference multimedia documents in the reference multimedia document base and i denotes one of these reference multimedia documents iε[1,n].

Vi denotes the number of votes received by the document i (where Vi may be equal to zero), and V is the total number of votes received by the set of reference multimedia documents. These votes come from the search by similarity of a set of descriptors of a document Q to be identified in the reference base, as described with reference to the prior art.

It is sought according to the disclosure to determine the selection threshold S corresponding to the minimum number of votes for which it can be assumed that the reference multimedia document i is similar to the multimedia document Q to be identified.

In order to determine this selection threshold S, one makes a contrary assumption, assuming that each of the V votes has been placed by randomly and uniformly choosing a reference multimedia document among the n multimedia documents referenced in the base (an assumption of random voting). For each vote, the probability of voting for the reference multimedia document i is therefore 1/n.

Indeed, the contrary approach in this context raises questions about whether chance is sufficient to explain the common points observed between the document to be identified and the reference documents. If this is not so, then there is effectively resemblance between the documents.

The fact of voting for the reference multimedia document i is a random phenomenon with two possible outcomes (generally called “success” and “failure”) for which the distribution of probability follows the law known as the Bernoulli distribution with a parameter 1/n. In other words, if a reference multimedia document of the base is chosen randomly and uniformly, there is one chance in n of choosing the document i. Thus, if one chooses the document i, the result is a success and if one chooses another document of the base, then the result is a failure.

When this experiment is reproduced V times, with V corresponding to the total number of votes, the probability that the document i will be chosen several times (Vi times) follows, for its part, a binomial law with two parameters: V and 1/n.

Thus, the probability that this reference multimedia document i will receive exactly Vi votes follows the binomial law with parameters V and 1/n. This probability is denoted as

$$B ( {V}_{i} ; V , \frac{1}{n} ) .$$

Thus a probabilistic representation of the number of votes allotted to a reference multimedia document (i) is determined as a function of the total number of documents present in said base (n), and the total number of votes (V).

It is then sought to determine a threshold of selection S of the similar multimedia documents (with S as an integer).

The probability that the number of votes allotted to the document i, denoted as Vi, is greater than or equal to the threshold of selection S can be written in the following form:

$$p ( {V}_{i} \geq S ) = 1 - {\sum }_{k = 0}^{S - 1} B ( k ; V , \frac{1}{n} )$$

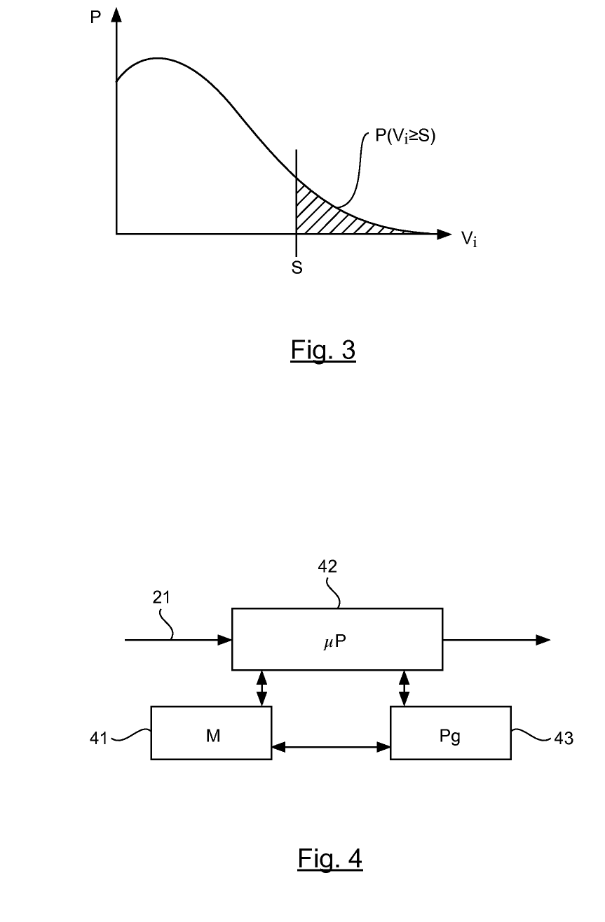

FIG. 3 represents an example of distribution of probability of the number of votes, with the assumption of random voting. More specifically, the hashed part represents the probability that the number of votes for a referenced multimedia document referenced i is above the threshold S or equal to it.

In this example of implementation of the disclosure, the decision on similarity or non-similarity of the multimedia document referenced i with the multimedia document Q to be identified is done by computing, for different rising values of S, the selection threshold starting from which the estimated number of false alarms observed is smaller than a decision value, for example equal to 1. This means that a “random” vote is not enough to explain such a number of votes but that a certain similarity is responsible for it. This number of false alarms can then be estimated from the probabilistic distribution illustrated in FIG. 3. In this example, the number of false alarms denoted as NFA(S), corresponds to the number of reference multimedia documents that have received at least S votes when these are made at random.

The number of false alarms is expressed by the following product: the probability that a referenced multimedia document has a number of votes greater than or equal to the selection threshold S, multiplied by the total number of multimedia documents in the base:

NFA(S)=n·p(Vᵢ≧S)

It can also be noted that the binomial distribution

$$B ( {V}_{i} ; V , \frac{1}{n} )$$

which comes into play is expressed by means of combinations which are themselves expressed by factorials (especially the factorial of V).

For the sake of facility of digital implementation of these computations, it is possible very reliably to approach the binomial distribution by a Poisson's law where the parameter L is equal to V/n.

It can be noted that such an approximation is valid when 1/n is small and V is great, which is generally the case for this context (in practice, this approximation is used when V>30 and L<5).

Thus, the binomial distribution can be approached by the following expression:

$$B ( k ; V , \frac{1}{n} ) \approx \frac{{L}^{k}}{k !} exp ( - L )$$

Although the Poisson's law also brings a factorial into play, this factorial, in the proposed implementation, pertains this time only to the small values and is easily computable.

It is also possible to reduce a recursive formulation of the binomial distribution thus approached:

$$\begin{matrix}\text{-} for k = 0 \text{:} B ( 0 ; V , \frac{1}{n} ) \approx exp ( - L ) ; \\ \text{-} for k > 0 \text{:} B ( k ; V , \frac{1}{n} ) = \frac{L}{k} B ( k - 1 ; V , \frac{1}{n} ) .\end{matrix}$$

This formulation can then be used to determine the value of the selection threshold S.

The following notations are introduced:
L=V/n, where L is the parameter of the Poisson's ratio;
s corresponds to the different threshold values tested; the magnitudes p and b, associated with the variable s, are defined as follows:
   b is the probability that a reference multimedia document has received exactly s votes, given the above-described random voting assumption;
   p is the probability that a reference multimedia document has received at least s votes, given the above-described random voting assumption.
First of all the following variables are initialized:
s=0, corresponding to the first selection threshold value tested;
b=exp(−L), corresponding to the probability that a reference multimedia document has received exactly zero votes, given the above-described random voting assumption;
p=1, corresponding to the probability that a reference multimedia document has received at least zero votes, given the above-described random voting assumption.

Then, the following steps are reiterated so long as the probability of false alarms NFA is greater than a predetermined decision value ε equal to 1 for example.

Thus, so long as n·p>ε (i.e. NFA(s)>ε):
the variable s is incremented by 1 (s:=s+1) and the variables that depend on it are updated;
the probability p−b is allotted to the variable p (p:=p−b), which thus becomes the probability that a reference multimedia document i has received at least s votes, given the above-described random voting assumption;
the probability b×L/s is allotted to the variable b (b:=b*L/s), which thus becomes the probability that a reference multimedia document i has received exactly s votes, given the above-described random voting assumption.

Finally, when the probability of false alarms NFA(s) is smaller than or equal to the predetermined decision value ε with ε=1 for example, a final value of s is allotted to the selection threshold S. The reference multimedia documents that have received a number of votes greater than or equal to S are assumed to be similar and are returned by the procedure.

In another variant, the number of false alarms is considered to be directly deducible from a selection threshold value, i.e. that the value NFA(s) is considered to be computable without using the value NFA(s−1). Since the function NFA(s) is monotonic and decreasing as a function of s, the selection threshold can be determined by dichotomy: the probability of false alarms NFA(s) is computed for different values s in an interval of possible values (generally with a lower boundary of 0 and an upper boundary linked to the number of descriptors used). The values of s are chosen so as to divide the interval into two sub-intervals. The estimation of the probability of false alarms NFA(s) at the boundaries of these sub-intervals and the monotonic property makes it possible to locate the sub-interval in which the function NFA(s) passes through the value ε. Only this sub-interval is preserved and the same operations are repeated until an interval is obtained with boundaries that are two consecutive integers. The value of the selection threshold S sought is then determined by the upper boundary of this interval.

According to another alternative implementation, the selection threshold S can be computed from one of the methods referred to here above preliminarily for different possible values of V and n, and then stored in a table (if the operation uses a data base having a fixed number of reference documents, it is also possible to do this tabulation solely for different values V). Thus, during a phase of analysis, it is no longer necessary to compute the threshold value S, but it is enough to read it in said table, thus further saving computation time.

### 3. The Case of the Comprehensive Descriptors

According to the disclosure, the multimedia document to be identified can be described by a comprehensive descriptor instead of a plurality of local descriptors.

A comprehensive descriptor of this kind generally takes the form of a vector with m dimensions.

In this case, the same technique as the one described here above is applied in likening each component (or sub-set of components) of the comprehensive descriptor to a local descriptor. In other words, each component (or sub-set of components) of the comprehensive descriptor of the document to be identified is deemed to be voting″ for a set (zero, one or more) of reference multimedia documents.

### 4. Advantages Related to the Disclosure

The technique of the disclosure has many advantages according to at least one of its embodiments, and especially:
it requires no parameter to be set if the predetermined decision value ε is fixed at ε=1;
the selection threshold is evaluated automatically and requires no costly handling of lists of values taken by the numbers of votes. In particular, the decision on similarity or absence of similarity relative to the selection threshold requires no scheduling of multimedia documents according to the number of their votes.
Similarly, the number of votes allotted to a “good” referenced multimedia document (i.e. a reference multimedia document similar to a multimedia document to be identified) does not need to be sharply distinguished from those allotted to reference multimedia documents that are not significant for detection;
it relies on a strict probabilistic formalism;
it can be used to control the number of false alarms. Indirectly, it is possible to deduce the probability that a selected reference multimedia document is a false alarm, from the number of votes that it has received. This characteristic can be useful especially for a video-copy detecting system in which a sequential filtering enables the results obtained at each image to be temporally aggregated;
it entails very few computations and its execution is therefore swift: according to one particular embodiment, it shortens the time needed to analyze all the local descriptors (or all the components of a comprehensive descriptor) of the multimedia document to be identified before a decision is taken. It can be decided, when V′ votes have been collected (with V′<V, where V is the total number of votes allotted while taking into account all the descriptors), to assess or read, in a table, the selection threshold S associated with the values V′ and n and use it to select reference multimedia documents if any similar to the multimedia document to be identified. It is then possible to choose to stop the analysis when at least one reference multimedia document has been identified as being similar.

### 5. Application of the Disclosure

The disclosure can be implemented especially in a system for detecting copies of a reference multimedia document (for example illicit copies of a protected document).

For example, it enables the efficient detection of the presence of copies of protected video content within a suspect video stream. In particular, the use of local descriptors according to one embodiment of the disclosure enables this detection to be robust with respect to deterioration, whether deliberate or not, of the original document.

The disclosure can thus be integrated into an automatic copyright protection system. It enables for example a content exchange hub such as YouTube, MaZoneVidéo, Dailymotion, etc (registered trademarks) to come into action very far upstream of the process for filing multimedia documents (text, image, audio or video documents) by filtering the illicit documents filed and thus achieving compliance with copyright protection rules.

Besides, and again in the context of content exchange hubs, such a system can be used to detect multiple copies of a same document referenced in a base of a server. Indeed, a same document is generally loaded by several users with different names and textual descriptions. Such a copy detection system can be applied to a multimedia document search engine to eliminate duplicates from the base and provide deduplicated request results. The user is thus presented with a single occurrence of each multimedia document, possibly with a link to the other copies).

Such a tool can also be used for purposes of analysis for content whose dissemination is authorized but for which it is desired to know the audience. Yet another possible application is the locating and rendering of a program (television broadcast, video etc) from an extract of the document.

More generally, the technique for obtaining a selection threshold and for counting votes according to the disclosure can be applied to any type whatsoever of multimedia document (sound, text, still images, video) as well as to any system bringing into play a voting strategy in which there is a large (non-infinite) number of potential candidates.

### 6. Structure of the Identification Device

Finally, referring to FIG. 4, one presents the simplified structure of an identification device implementing an identification technique according to the particular embodiment described here above.

Such a device comprises a memory 41 constituted by a buffer memory, a processing unit 42 equipped for example with a microprocessor μP and driven by the computer program 43 implementing the identification method according to the disclosure.

At initialization, the code instructions of a computer program 43 are loaded for example into a RAM and then executed by the microprocessor of the processing unit 42. At an input, the processing unit 42 receives a multimedia document 21 to be identified.

The microprocessor of the processing unit 42 implements the steps of the identification method described here above, according to the instructions of the computer program 43, to check on whether or not the multimedia document to be identified is similar to at least one multimedia document referenced in a base of reference multimedia contents. To this end, the identification device comprises, in addition to the buffer memory 41, means for allotting a number of votes to at least one reference multimedia document and selecting means for selecting, from among at least one reference multimedia document, multimedia documents similar to the multimedia document to be identified. More specifically, the selecting means comprises:
means for determining a probabilistic distribution of the number of votes allotted to a reference multimedia document, as a function of the total number of documents referenced in said base and of the total number of votes, given an assumption of random voting,
means for obtaining a threshold of selection of said similar multimedia documents, from among the reference multimedia documents, on the basis of said probabilistic distribution.

These different means are driven by the microprocessor of the processor unit 42

The identification device delivers at output zero, one or more base multimedia reference having a number of votes greater than the selection threshold.

Such a device can be integrated especially into a system for detecting copies of multimedia documents.

Although the present disclosure has been described with reference to one or more examples, workers skilled in the art will recognize that changes may be made in form and detail without departing from the scope of the disclosure and/or the appended claims.

1. A method for identifying a multimedia document, aimed at checking on whether or not the multimedia document to be identified is similar to at least one reference multimedia document referenced in a base of reference multimedia documents, comprising the following steps:
allotting a number of votes to at least one reference multimedia document, each of said votes being significant of a proximity between a descriptor of said reference multimedia document and a descriptor of said multimedia document to be identified, and
selecting, from among said at least one reference multimedia document, multimedia documents similar to said multimedia document to be identified, wherein the selecting step comprises the following sub-steps:
determining a probabilistic distribution of the number of votes allotted to a reference multimedia document, as a function of the total number of documents referenced in said base and of the total number of votes, given an assumption of random voting, and
obtaining a threshold of selection of said similar multimedia documents, from among the reference multimedia documents, on the basis of said probabilistic distribution.

2. The method according to claim 1, wherein said selection threshold is defined while taking into account a number of possible false alarms, estimated from said probabilistic distribution, so that the number of false alarms for the selection threshold is smaller than a predetermined decision value.

3. The method according to claim 2, wherein said decision value is equal to 1.

4. The method according to claim 1, wherein said probabilistic distribution implements a binomial law
$$B ( {V}_{i} ; V , \frac{1}{n} ) ,$$
where:
n is the total number of multimedia documents referenced in the base;
V is the total number of votes;
Vᵢ is the number of votes for a reference multimedia document i referenced in said base.

5. The method according to claim 4, wherein said binomial law is approximated by a Poisson law with a parameter L=V/n, according to the following equation:
$$B ( k ; V , \frac{1}{n} ) \approx \frac{{L}^{k}}{k !} exp ( - L ) .$$

6. The method according to claim 2, wherein said step of obtaining a selection threshold implements an iterative algorithm on the basis of a selection threshold setting value equal to zero and so long as the number of false alarms for said selection threshold is greater than said decision value.

7. The method according to claim 1, wherein said selection threshold is determined prior to said selection step for different values of the total number of multimedia documents referenced in said base and of the total number of votes and is stored in a table, and wherein said step of obtaining a selection threshold implements a reading of said table.

8. The method according to claim 1, wherein said multimedia documents belong to the group comprising:
an image,
a video,
an audio content,
a textual content.

9. The method according to claim 1, wherein said multimedia documents are described by at least two local descriptors, characterizing at least one of an aspect or a region of said multimedia documents, a vote being allotted to a reference multimedia document when one of the descriptors of the multimedia document to be identified is similar to one of the descriptors of said reference multimedia document.

10. The method according to claim 1, wherein said multimedia documents are described by a comprehensive vector component comprising at least two components, a vote being allotted to a reference multimedia document when one of the components of the descriptor of the document to be identifier is similar to one of the components of the descriptor of said reference multimedia document.

11. A computer program product recorded on a computer-readable carrier, comprising program code instructions for implementing a method for identifying a multimedia document, aimed at checking on whether or not the multimedia document to be identified is similar to at least one reference multimedia document referenced in a base of reference multimedia documents, the method comprising:
allotting a number of votes to at least one reference multimedia document, each of said votes being significant of a proximity between a descriptor of said reference multimedia document and a descriptor of said multimedia document to be identified, and
selecting, from among said at least one reference multimedia document, multimedia documents similar to said multimedia document to be identified, wherein the selecting step comprises the following sub-steps:
determining a probabilistic distribution of the number of votes allotted to a reference multimedia document, as a function of the total number of documents referenced in said base and of the total number of votes, given an assumption of random voting, and
obtaining a threshold of selection of said similar multimedia documents, from among the reference multimedia documents, on the basis of said probabilistic distribution.

12. A device for identifying a multimedia document, aimed at checking on whether or not the multimedia document to be identified is similar to at least one reference multimedia document referenced in a base of reference multimedia documents, comprising:
means for allotting a number of votes to at least one reference multimedia document, each of said votes being significant of a proximity between a descriptor of said reference multimedia document and a descriptor of said multimedia document to be identified, and
selecting means for selecting, from among said at least one reference multimedia document, multimedia documents similar to said multimedia document to be identified, wherein said selecting means comprises:
means for determining a probabilistic distribution of a number of votes allotted to a reference multimedia document, as a function of a total number of documents referenced in said base and of the total number of votes, given an assumption of random voting, and
means for obtaining a threshold of selection of said similar multimedia documents, from among the reference multimedia documents, on the basis of said probabilistic distribution.
